(19) United States
(12) Patent Application Publication
(10) Pub. No.: US 2020/0175756 A1
(43) Pub. Date: Jun. 4, 2020

(54) TWO-DIMENSIONAL TO THREE-DIMENSIONAL SPATIAL INDEXING

(71) Applicant: Intuitive Research and Technology Corporation, Huntsville, AL (US)

(72) Inventors: Chanler Crowe, Madison, AL (US); Michael Jones, Athens, AL (US); Kyle Russell, Huntsville, AL (US); Michael Yohe, Meridianville, AL (US)

(21) Appl. No.: 16/431,880

(22) Filed: Jun. 5, 2019

Related U.S. Application Data
(60) Provisional application No. 62/774,580, filed on Dec. 3, 2018.

(51) Int. Cl. G06T 17/20; G06T 15/04; G06T 19/00

(52) U.S. Cl. CPC G06T 17/20; G06T 2210/41; G06T 19/006; G06T 15/04

(57) ABSTRACT

A method for converting static two-dimensional images into three-dimensional images indexes between the two-dimensional images and three-dimensional images, which allows for referencing and consultation between the two sets of images.

### REFERENCE TO RELATED APPLICATIONS

This application claims priority to Provisional Patent Application U.S. Ser. No. 62/774,580, entitled “Three-Dimensional Spatial Indexing” and filed on Dec. 3, 2018, which is fully incorporated herein by reference.

### BACKGROUND AND SUMMARY

This application relates generally to a system and method for creating and mapping a set of three-dimensional images to a set of two-dimensional images.

Some methods of imaging, such as medical imaging, provide images of horizontal slices of the interior of the human body. There are many medical imaging systems used to acquire medical images suitable for diagnosis of disease or injury, such as: X-ray, CT scans, MRI scans, ultrasound, and nuclear medicine systems. These systems can produce large amounts of patient data, which are generally in the format of a series of continuous images representing two-dimensional slices of the scanned object. These images are used for diagnostic interpretation by physicians viewing potentially hundreds of images to locate the cause of the disease or imagery.

There is existing software capable of converting the two-dimensional images to three-dimensional models. These three-dimensional models are one, smooth surface, and they are primarily used for medical imaging. However, they do not reference or map the source of their image back to the original two-dimensional images. They also only allow for manipulation after the user loads it into evaluation software to visualize and manipulate the mesh, and they only allow for manipulation of the entire image at once.

What is needed is a system and method to improve diagnostic process, workflow, and precision through advanced user-interface technologies in a virtual reality environment. This system and method should allow the user to upload two-dimensional images, which may be easily converted to a three-dimensional mesh. This three-dimensional mesh should contain internal spatial mapping allowing the three-dimensional images to be built with internal indexing linking back to the original two-dimensional images. This spatial mapping with internal indexing linking back to the original two-dimensional images is referred to herein as “spatial indexing.”

The disclosed system and method allows a user to upload images. The method will then use the images to create a three-dimensional model of the image. When the user selects certain areas of three-dimensional model, the two-dimensional medical images reflect the area selected. Likewise, when a two-dimensional image is selected, the corresponding aspects of the three-dimensional model are highlighted.

The present invention allows for the selection and manipulation of discreet aspects of the three-dimensional model.

One embodiment of the current invention would use medical images to create a 3D mesh model of the images. The method converts the two-dimensional medical images to two-dimensional image textures, applies the textures to three-dimensional plane meshes, and stacks the two-dimensional plane images, which are then capable of manipulation in the three-dimensional environment. The method then uses the two-dimensional image textures to create the images to generate a three-dimensional mesh based upon the two-dimensional image pixels. The three-dimensional mesh model will be linked to the individual 2D medical images, and when an aspect of the three-dimensional image is selected, the corresponding two-dimensional image will be highlighted. Selecting a two-dimensional image will also highlight the corresponding aspect of the three-dimensional image.

### BRIEF DESCRIPTION OF THE DRAWINGS

The features and advantages of the examples of the present invention described herein will become apparent to those skilled in the art by reference to the accompanying drawings.

FIG. 1 is a flow diagram depicting a system for mapping two-dimensional and three-dimensional images according to an exemplary embodiment of the present disclosure.

FIG. 2 is a flow diagram depicting a system for representing data in three-dimensional images, according to one embodiment of the present disclosure.

FIG. 3 is a flow diagram depicting a system for importing two-dimensional data into a manipulatable format according to one embodiment of the present disclosure.

FIG. 4 is a flow diagram describing the creation of planar meshes from two-dimensional images according to one embodiment of the present disclosure.

FIG. 5 is a flow diagram depicting the use of two-dimensional data in the creation of three-dimensional mesh according to one embodiment of the present disclosure.

FIG. 6 is a flow diagram depicting the enabling of mapping between the two-dimensional and three-dimensional images according to one embodiment of the present disclosure.

FIG. 7A is an illustration of the two-dimensional planar image stack and three-dimensional mesh generated by the methods disclosed herein.

FIG. 7B is an illustration of the user selecting a two-dimensional image for examination and the mapping of the location of the user-selected two-dimensional image to the correlated location of three-dimensional mesh.

FIG. 8A is an illustration of the three-dimensional mesh with a user-selected slice and a two-dimensional planar stack of images.

FIG. 8B is an illustration of the user selection part of the three-dimensional image for examination.

FIG. 9 depicts an exemplary display as seen by a user, according to an embodiment of the present disclosure.

### DETAILED DESCRIPTION

In some embodiments of the present disclosure, the operator may use a virtual controller to manipulate three-dimensional mesh. As used herein, the term “XR” is used to describe Virtual Reality, Augmented Reality, or Mixed Reality displays and associated software-based environments. As used herein, “mesh” is used to describe a three-dimensional object in a virtual world, including, but not limited to, systems, assemblies, subassemblies, cabling, piping, landscapes, avatars, molecules, proteins, ligands, or chemical compounds,

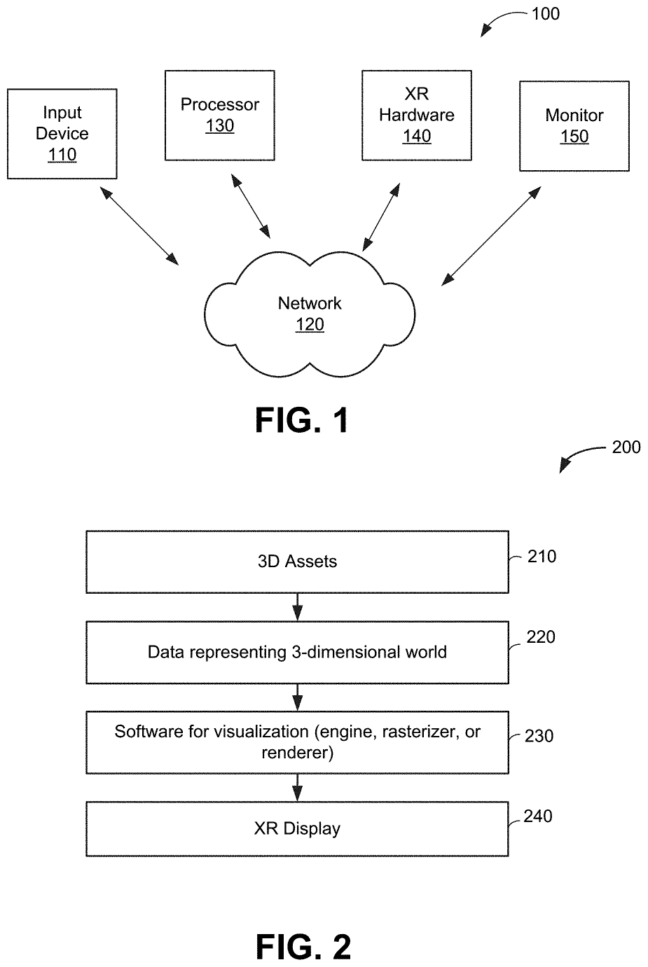

FIG. 1 depicts a system 100 for supporting two-dimensional to three-dimensional spatial mapping (not shown), according to an exemplary embodiment of the present disclosure. The system 100 comprises an input device 110 communicating across a network 120 to a processor 130. The input device 110 may comprise, for example, a keyboard, a switch, a mouse, a joystick, a touch pad and/or other type of interface, which can be used to input data from a user (not shown) of the system 100. The network 120 may be a combination of hardware, software, or both. The system 100 further comprises XR hardware 140, which may be virtual or mixed reality hardware that can be used to visualize a three-dimensional world, for example XR headsets, augmented reality headset systems, and augmented reality-based mobile devices, such as tablets and smartphones. The system 100 further comprises a video monitor 150 that is used to display the three-dimensional data to the user. In operation of the system 100, the input device 110 receives input from the computer 130 and translates that input into an XR event or function call. The input device 110 allows a user to input data to the system 100, by translating user commands into computer commands.

FIG. 2 illustrates the relationship between three-dimensional assets, the data representing those assets, and the communication between that data and the software, which leads to the representation on the XR platform. Three dimensional assets 210 may be any three-dimensional assets, which are any set of points that define geometry in three-dimensional space. The data representing a three-dimensional world 220 is a three-dimensional mesh that may be generated by importing three dimensional models, images representing two-dimensional data, or other data converted into a three-dimensional format. The software for visualization 230 of the data representing a three-dimensional world 220 allows for the processor 130 (FIG. 1) to facilitate the visualization of the data representing a three-dimensional world 220 to be depicted as three-dimensional assets 210 in the XR display 240.

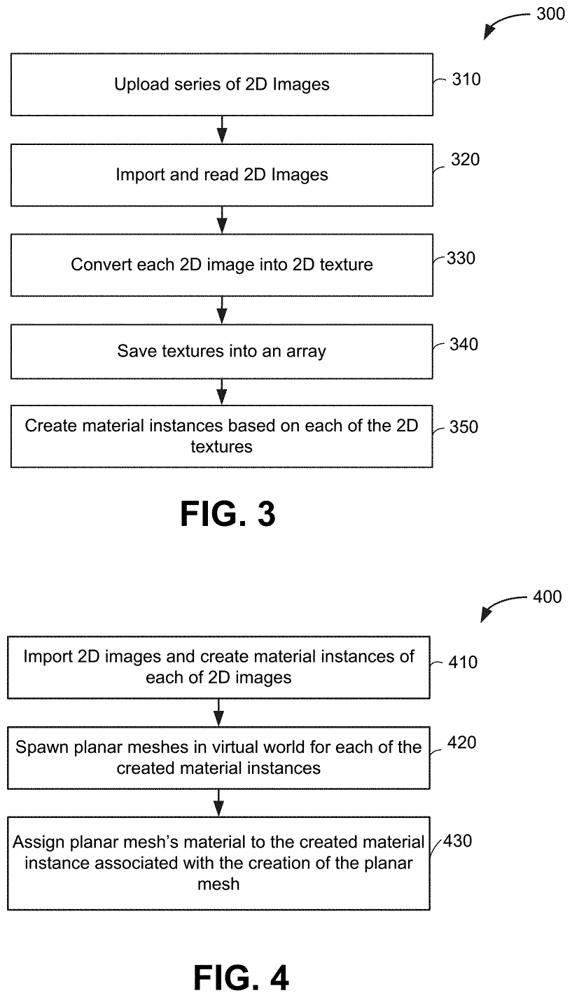

FIG. 3 depicts an exemplary method 300 of data importation and manipulation performed by the processor according to an embodiment of the present disclosure. In step 310 of the method, the user uploads the series of two-dimensional images, which the processor uses to create a three-dimensional mesh. Step 310 could be done through a GUI interface, copying the files into a designated folder, or other methods according to the present embodiment. In step 320 of the method, the processor imports the two-dimensional image. In step 330 of the method, the processor converts the two-dimensional images into two-dimensional image textures capable of manipulation by the program. The textures created according to step 330 are then saved into an array for further manipulation and reference, in step 340. In step 350, the processor creates material instances for each of the two-dimensional textures at a 1:1 ratio 340.

FIG. 4 depicts an exemplary process 400 of creating planar depictions of the two-dimensional images. Step 410 depicts the process of data importation and manipulation performed by the processor also described by FIG. 3. In step 420, the processor spawns a new planar mesh in the virtual world for each of the material instances described in step 410. In step 430, the planar meshes are automatically placed in virtual space and become visible to the user.

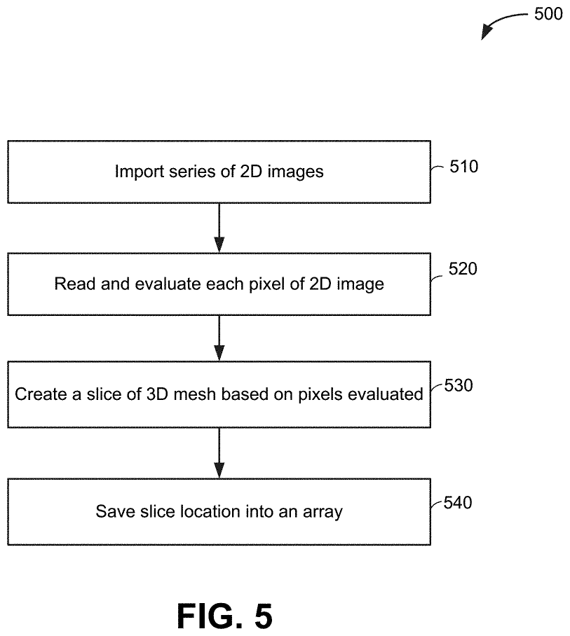

FIG. 5 depicts an exemplary process 500 of using a series of two-dimensional images to create the three-dimensional mesh. In step 510, the processor imports the designated series of two-dimensional images. In step 520, the processor reads each two-dimensional image and evaluates it, going through the image pixel by pixel and determining whether each pixel reaches a threshold color value. In step 530, the processor creates a slice of mesh based on the pixels in the two-dimensional image that reached the threshold color value. In step 540, each location of the slices of the three-dimensional mesh is saved into an array for later evaluation and reference.

A practical example of the method disclosed herein is a user uploading a set of CT scans of a human heart. The software outputs a scale model of the scanned heart, in the form of raw two-dimensional images and a three-dimensional mesh image, as discussed herein.

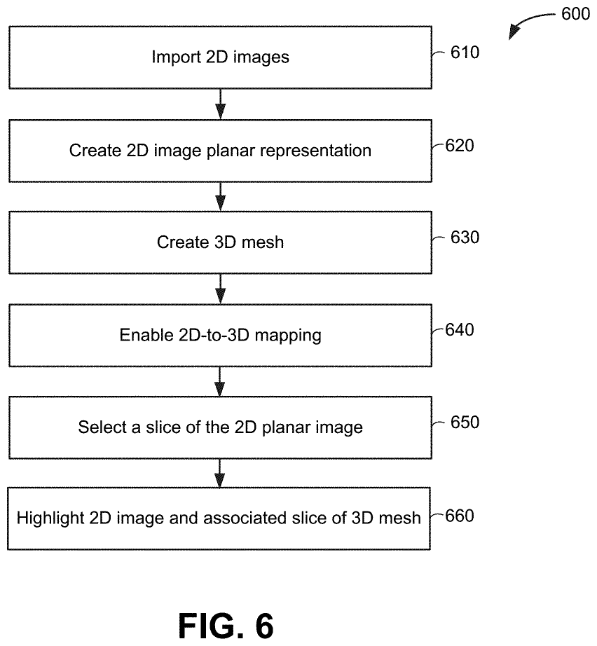

FIG. 6 depicts an exemplary process 600 of utilizing the two-dimensional to three-dimensional mapping functionality as described in step 530 (FIG. 5). In step 610, the two-dimensional images are imported according to the method 300 (FIG. 3). In step 620, the planar representations are created according to the method 400 (FIG. 4). In step 630, the three-dimensional mesh is created from the imported two-dimensional images according to the method 500 (FIG. 5). In step 640, the 2D-to-3D mapping is enabled. According to one embodiment of the present disclosure, in step 640 the processor automatically performs the steps 610-630. According to another embodiment of the present disclosure, the user can enable the 2D-to-3D mapping by using an input device such as: a keyboard input, controller input, or panel interaction. In step 650, the user selects a slice of the two-dimensional planar image using an input device, which may be shown to be highlighted under some embodiments of the invention. The mapping between two-dimensional and three-dimensional images as depicted in 500 (FIG. 5) allows the processor to know which three-dimensional image is also selected based upon the mapping between the two-dimensional and three-dimensional images. In step 660, the slice of the two-dimensional image selected is highlighted on a display. The software's mapping allows for the location of the highlighted slice to alert the processor to also highlight the corresponding three-dimensional mesh. In another embodiment, the user can select and highlight the three-dimensional mesh, which will highlight the corresponding section of the two-dimensional image, due to the mapping as described in FIG. 5.

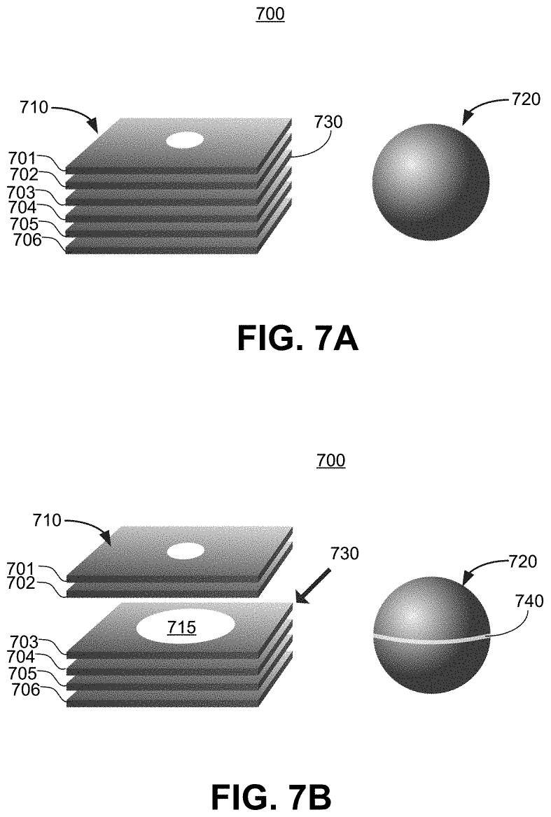

FIG. 7A illustrates an exemplary two-dimensional planar image stack 710 and an associated three-dimensional mesh 720 shown on a display 700 as viewed by a user. The images in FIG. 7A are created using the methods described herein. Each of the two-dimensional images 701, 702, 703, 704, 705, and 706 in the stack 710 is an uploaded two-dimensional planar image and represents a planar slice of the 3D mesh 720. The example in FIG. 7A illustrates six (6) two-dimensional planar images 701-706 in the stack 710, though in practice there may be more or fewer images in a stack 710. Each image in the stack 710 represents a slice of a 3D object. For example, each image in the stack 710 may be a medical scan of a human body part.

FIG. 7B illustrates user selection of a single two-dimensional image 703 in the stack 710, as shown on the display 700. The user selects the single two-dimensional image 703 using an input device 730. The input device 730 could be a keyboard, mouse, controller, or other similar device. When the user selects the single two-dimensional image 703, the stack 710 “opens up” to show the selected image 703. The image 703 may also be displayed as a separate image (not shown) viewed from the top 715 of the image. At the same time, when the user selects the two-dimensional image 703, a slice 740 of the three-dimensional mesh 720 associated with the selected two-dimensional image 703 is highlighted in the display 720. The term “highlight” in this application refers to any way of indicating the specific slice of a three-dimensional mesh or specific two-dimensional planar image that has been selected or is associated with the selected image or slice. The highlighting action could be, for example, a change of color, or an indicating arrow (not shown), or the like. The selected two-dimensional image 703 is thus spatially indexed with the correlating slice 740 of the three-dimensional mesh 720.

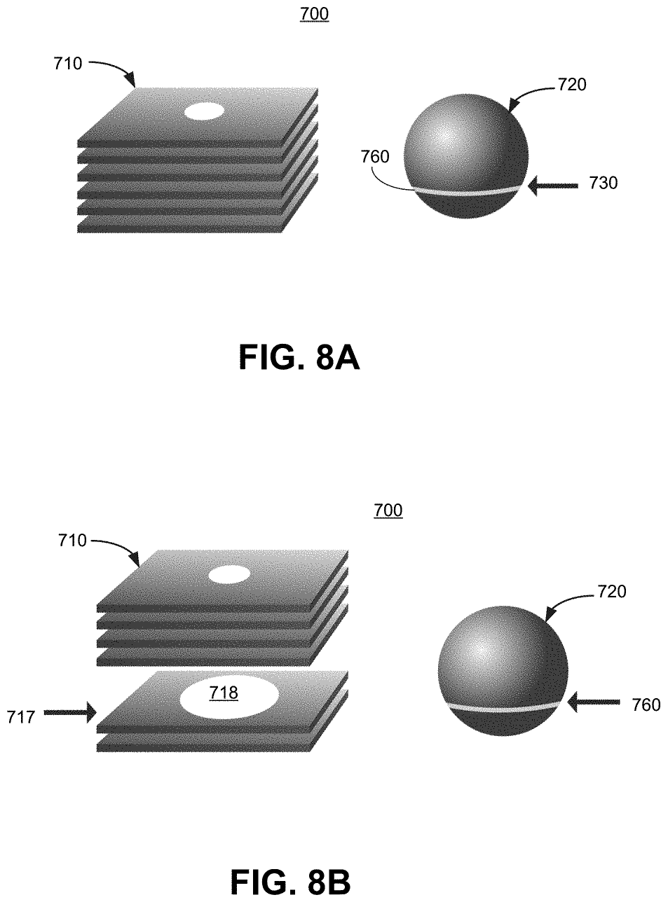

FIG. 5A illustrates the two-dimensional planar image stack 710 and associated three-dimensional mesh 720. In FIG. 8A, a user has selected a slice 760 of the three-dimensional mesh 720 using the input device 730. When the slice 760 is selected, the slice 760 is highlighted on the three-dimensional mesh 720.

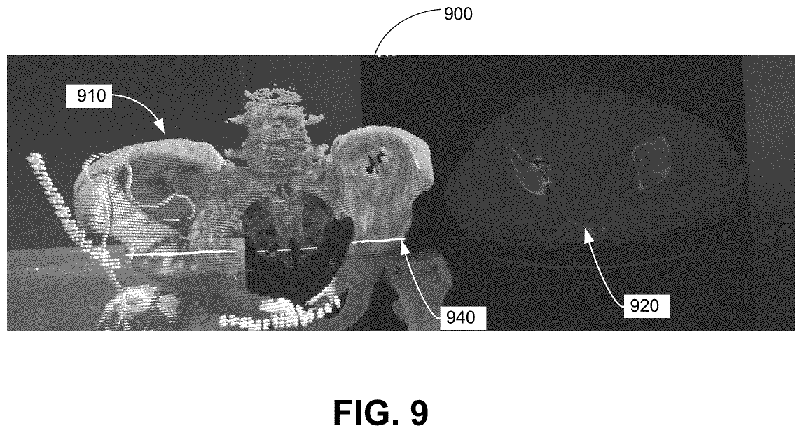

FIG. 8B illustrates two-dimensional planar image stack 710 opening up after the user selected the slice 760 (in FIG. 5A). The stack 710 opens up to display the two-dimensional slice 717 associated with the selected 3D slice 760. The white portion 718 on the slice 717 is an image corresponding to the slice 760. The slice 717 may also be shown on the display 710 in a separate area, viewed from the top of the slice 717, as further illustrated in FIG. 9.

FIG. 9 depicts an exemplary display 900 as seen by a user, according to an embodiment of the present disclosure. A three-dimensional mesh 910 was formed from two-dimensional images (not shown) using the methods disclosed herein. The mesh 910 is of a human pelvis in this example. The user has selected a slice 940 of the mesh 910, and the slice 940 is highlighted. A two-dimensional image 920 representing the selected slice 940 is displayed to the user via the display 900.

What is claimed is:

1. A method for spatially indexing two-dimensional image data with three-dimensional image data for use in a virtual reality environment, comprising:
uploading two-dimensional images to form two-dimensional data;
creating three-dimensional mesh from the two-dimensional data at runtime;
creating spatial indexing using the two-dimensional data and three-dimensional data;
linking the two-dimensional and three-dimensional data; and
displaying on a display the linked two-dimensional and three-dimensional data to a user via the three-dimensional mesh created from the two-dimensional data.

2. The method of claim 1, wherein the two-dimensional images comprise medical images used to create two-dimensional textures.

3. The method of claim 2, wherein the two-dimensional textures are used to create the three-dimensional mesh.

4. The method of claim 1, wherein the two-dimensional data becomes two-dimensional textures.

5. The method of claim 4, wherein the two-dimensional textures are used to form the three-dimensional mesh.

6. The method of claim 1, wherein internal references allow the user to use the two-dimensional and three-dimensional images for spatial indexing.

7. The method described in claim 6, wherein when the user selects an aspect of the three-dimensional mesh, a corresponding two-dimensional image is highlighted on the display.

8. The method described in claim 6, wherein when the user selects an aspect of the two-dimensional image, the corresponding aspect of the three-dimensional mesh is highlighted on the display.

9. A method for spatially indexing two-dimensional image data with three-dimensional image data for use in a virtual reality environment, comprising:
importing two-dimensional images;
creating a two-dimensional planar representation of the two dimensional images;
creating a three-dimensional mesh correlating to the two-dimensional planar representation, the three-dimensional mesh comprising a plurality of slices;
displaying the two-dimensional planar representation and the three-dimensional mesh on a display;
enabling mapping of the two-dimensional planar representation to the three-dimensional mesh.

10. The method of claim 9, further comprising selecting a slice of the two-dimensional planar image, by a user, the selected slice corresponding with a portion of the three-dimensional mesh.

11. The method of claim 10, further comprising automatically highlighting the selected portion of the three-dimensional mesh on the display.

12. The method of claim 11, further comprising automatically highlighting the two-dimensional planar image associated with the selected slice on the display.

13. The method of claim 9, further comprising selecting one two-dimensional image, by the user, the selected image corresponding with a slice of the three-dimensional mesh.

14. The method of claim 13, further comprising automatically highlighting the two-dimensional planar image associated with the selected slice on the display.

15. The method of claim 14, further comprising automatically highlighting the selected slice of the three dimensional mesh on the display.

16. The method of claim 9, wherein the two-dimensional planar representation comprises a stack of two-dimensional images, each two-dimensional image corresponding to a slice of the three-dimensional mesh.

17. The method of claim 9, wherein the two-dimensional images comprise medical images used to create two-dimensional textures.

18. The method of claim 9, wherein the two-dimensional data becomes two-dimensional textures.

19. The method of claim 18, wherein the two-dimensional textures are used to create the three-dimensional mesh.

20. The method of claim 18, wherein a processor transforms the two-dimensional textures into the three-dimensional mesh.
